(19) United States
(12) Patent Application Publication
(10) Pub. No.: US 2004/0029561 A1
(43) Pub. Date: Feb. 12, 2004

(54) Revert charging in a telecommunication network

(76) Inventors: Signe Marie Holter, Oslo (NO); Olav Afdal, Stepeden (NO)

Correspondence Address: ERICSSON INC., 6300 LEGACY DRIVE, M/S EVW2-C-2, PLANO, TX, 75024, US

(21) Appl. No.: 10/344,191

(22) PCT Filed: Aug. 9, 2001
(86) PCT No.: PCT/NO01/00336

(51) Int. Cl. H04M 11/00

(52) U.S. Cl. 455/405

(57) ABSTRACT

The present invention relates to a method for enabling a called party to optionally pay for a call or service, or parts of a call or service (hereafter, a call or service will only be designated as a call) initiated by a calling party. In an exemplary embodiment of the present invention, when call is set up in a telephony network by a calling party, in case of call prepay, it will be determined if there is money on an account used for call prepay, accessible from the network. If there is not, the called party will be prompted whether he/she accepts to switch charging direction or not. If the called party accepts, he/she will be charged for the call. In the opposite case, the call will be disconnected. The called party can also at any time switch the direction of the charging during a call for which the calling party at the time being is paying. In addition, the present invention gives the subscribers opportunity to create a list of accepted charging called parties. All incoming calls will be checked against the list, and only reverse call requests from members of the list will pass through.

All processes in the present invention are automatically executed by software of the network, terminals, nodes and exchanges involved.

### FIELD OF THE INVENTION

The present invention relates to a method for charging telephone calls, in particular for enabling a called party to optionally pay for a call established by a calling party.

### BACKGROUND OF THE INVENTION

In telephony and telecommunication systems, there are usually implemented charging systems, in which all telephone calls and services for a certain period back in time are registered. The registration comprises information regarding e.g. call duration, call type (long distance, short distance, etc.), call costs, and, of course, information and identity of the calling and the called parties. It is normally assumed that the calling party will pay for the call, and is therefore charged for the call or service costs. The charge is stored in a storing means integrated in or connected to the telecommunication system, which is used. Generally, the call can either be postpaid through a billing system based on the stored charging information, or, alternatively, it could be prepaid or instantaneously paid by charging an account or a calling card belonging to a subscriber initiating a call (i.e. calling party).

However, in certain situations it is desired to allow the called party to be charged for the call. The called party himself should of course, control this, but in most cases, it is probably requested by the calling party.

A known solution for allowing the called party to be charged for the call which is widely used, is to call an operator when invoking a reverse call. The operator will then contact the one who is about to receive the call, and ask if he/she is willing to take the cost for the call connection.

A disadvantage concerning the existing solution is that the calling party has to involve a third person in order to request an approval from the receiver of the call, and this is quite inefficient and relatively expensive, at least for the operator.

In addition, when using this solution, the operator has to establish the new connection in the opposite direction, in order to revert the charge from the calling party to the called party.

Further disadvantages of the existing solution is that, during a call, there is no possibility for changing to a reverse call without breaking the connection and establish the call once again by use of an operator.

### SUMMARY OF THE INVENTION

An object of the present invention is to provide a method eliminating the drawbacks described above.

More specifically, a main object of the present invention is to automate and make the ordering of a reverse call more efficient, cheaper and more accessible for both the subscribers as well as for the telephone operator.

This is obtained by the present invention by making it possible to revert the charging both before the call is established as well as during the call, all automatically accomplished through software incorporated in the telecommunication system.

A further object is to make the initiation of the reverse call fully controlled by the called party after a request from the calling party. Thus, in the present invention, it is made possible for the called party to predetermine a list of accepted revert charging called parties.

The above objects are achieved by a method characterized in the features defined by the claims enclosed.

### BRIEF DESCRIPTION OF THE DRAWINGS

In order to make the invention more readily understandable, an exemplary embodiment of the present invention will be described with reference to the accompanying drawings in the following.

FIG. 1 illustrates the definition of the expressions “calling party” and “called party”.

FIG. 2 is a float diagram illustrating an exemplary embodiment of the method in the present invention.

FIG. 3 illustrates an example of call connection, according to the present invention, when prepaying is used.

### DETAILED DESCRIPTION

With reference to the abovementioned figures, there will in the following be described an example of how a method according to the present invention may be implemented.

The example concerns a new service called “revert charging” of call connections.

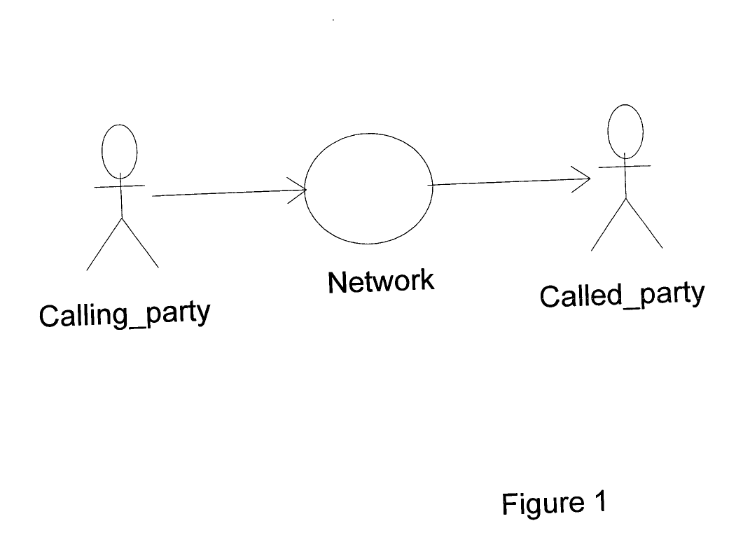

FIG. 1 shows the parties involved. The calling party (1) initiates the connection. The called party (3) is the one he/she wants to reach. In order to reach this second party (for instance a person, a service provider in a network, or a company), he/she is using the network. This network might for example be the telephony network or the Internet.

In addition, the network will have to have an access to an account holding account data.

According to the present invention, it should be possible to revert the charging of a connection, either during call establishment or during the active connection. This should be noted when revert charging service is possible. The further procedures will here follow the so-called collect call service.

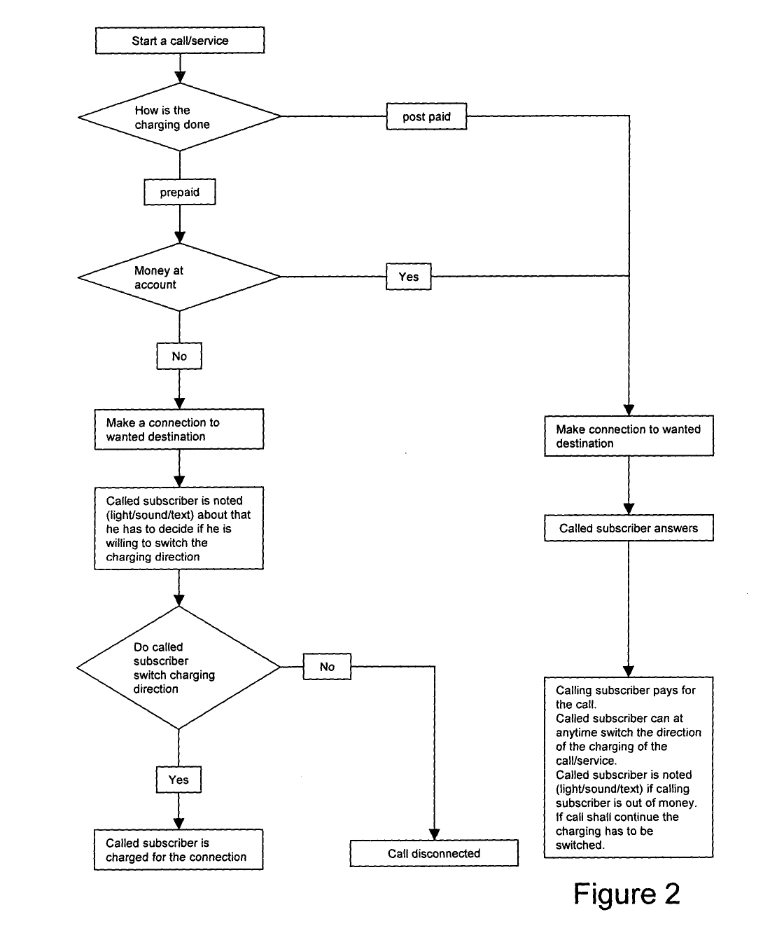

Now, turning to the float diagram of FIG. 2, an example of a preferred embodiment of the present invention will be described.

A calling party (1) is establishing a call or a service in e.g. a telephony network (4). A node or an exchange within the network determines if the charge will be done postpaid or prepaid (5), according to registered information stored in a memory device of the network. Similarly, in case of prepaid charging, it also has to be determined if there is money left at the calling party's (1) account (9). If not, the network makes a connection to the desired destination (i.e. the called party) (10), as it is known in the art. Subsequently, the called party (3) will then be requested through a notification (11) if he/she is willing to take the costs for the call from that actual time until the connection is closed. Examples of notification are a special tone, a light or a text message. The called party (3) is responding positively, for example, by dialling a certain number, or typing a password. An exchange or an intelligent node of the network (12) determines the response. If the response is negative or if no special actions are taken by the called party (3) during a certain period of time, the call will be disconnected. However, when the response is positive (the called party accepts the reverse call), the called party (3) will be charged for the call, and the costs will be taken care of by the billing system of the telephony network, as known in the art, or by an instantaneous payment (e.g. charging the called party's (3) credit card, a calling card or by paying cash).

Now returning to step (5) and (9) in FIG. 2, if it is determined that the charging will be postpaid, or if there is money on the calling party's (1) account, the network makes a connection to the desired destination (i.e. the called party) (6), as it is known in the art. The called party (3) will then be invoked in a normal way, and if he/she answers (7), the calling party (1) will pay for the call. The called party (3) can at any time switch the direction of the charging of the call (8) by e.g. dialling a specific code. He/she will also be noted (e.g. by light, sound or text) if calling party (1) is out of money, and then the charging has to be switched for the call to be continued.

As mentioned above, a call connection is either pre- or postpaid. The procedures for prepaid calls will be applicable for those who are making the call connection by calling card or a card with bank accept or credit card. A check against an account has to be done in order to check the amount of money. The one who is holding the account information might be a telephony company, bank or credit card company depending on the type of prepaid service which is being used.

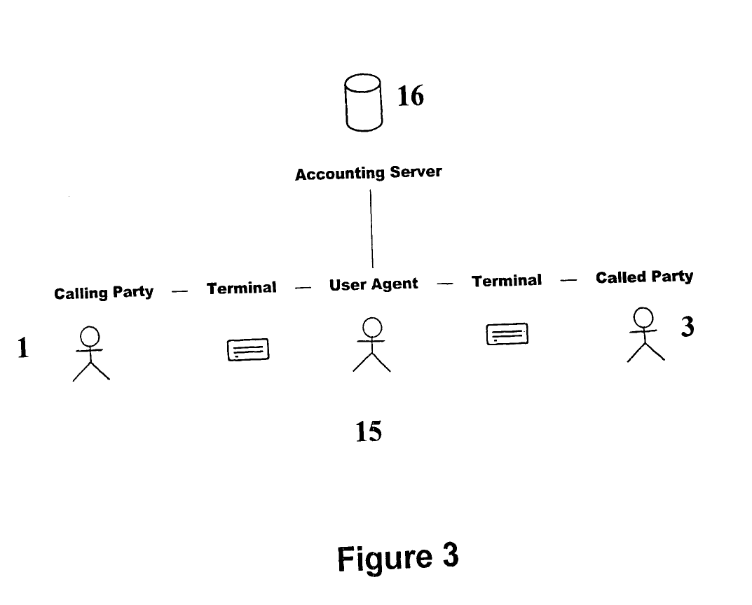

FIG. 3 shows an example of a call connection, when prepaying is being used, and describes step (9) in FIG. 2 in a more detailed manner. The terminal will access the “UserAgent” (15), to make a call. The “UserAgent” (15) will check the calling users account with the accounting server (16). The accounting server (16) is directly in contact with the account of the calling user. If no money is available, the “revert charging” service is started, according to step (11) in FIG. 2. Similar action will be executed during a call when the calling party (1) runs out of money, or when the called party (3) switches the direction of the charge.

A prepaid call is directly charged towards an account. This account can be a bank account, a local account at the operator, a credit card etc. The account will be checked at call set-up. In order to make a call, the account must be loaded with an amount of money. According to FIG. 2, calling party might reach the destination without having money on his/her account. In order to open the connection, the receiver of the call has to revert the charging.

A postpaid call is paid after the call is finished. The telephony company sends a bill to the user.

In a preferred embodiment of the present invention, the called party (3) has the opportunity to make up a list of accepted revert charging called parties. Such a list has to be predetermined by the called party (3) before making use of it in a call. The list may be created through a terminal connected to the network, and stored within a node or an exchange within the network. All incoming calls will be checked against the revert charging screening list before the called party (3) is being prompted by the revert charging service if he/she accepts revert charging. Only reverse call requests from subscribers included in the list will then be reaching the called party (3).

The fact that the example described above allows automation of the revert charging, is one of the main advantages of the present invention. No manual actions of a third party (i.e. a operator) is necessary, thus making revert charging more efficient and cheap for both the subscribers and the telephony operator.

The invention also opens for initiation of revert charging during a call, and this is certainly an advantage e.g. in the situations when the calling party is prepaying a call and runs out of money. In that case, the call would normally have been closed down, but by using the present invention, the call would be allowed to continue if the called party accepted reverts charging.

Possibly, the revert charging service may cause a problem if too many requests occur from calling parties from which the called party never would allow revert charging. This problem is eliminated by the present invention through the above described list of accepted revert charging called parties. The called party may on this list predetermine which calling parties who are allowed to reach him/her with a revert charging request.

Note that the foregoing example of the present invention is discussed for illustrative purposes, and is not meant to limit the invention in any way. Nevertheless, different changes and supplements may be added without departing the scope of the invention defined in the following claims.

1. A method for charging a call or a service provided by a service provider and/or a telephony operator in a communication network (2), to which a calling party (1) and a called party (3) is connected, each accessing said communication network through a terminal, said method managed by an intelligent node within said communication network, said charging is being serviced by a means of payment associated with said calling party (1) or called party (3),
characterized in
transmitting a reverse charging request to said called party (3) from said intelligent node asking if he/she accepts being charged partly or totally for said call or service,
passing said request to said called party (3) only if the calling party (1) is included in a predefined list of subscribers stored in a storing means within said communication network (2) associated with, created by and accessible for said called party (3), which predefined list identifying subscribers from which said called party (3) allows reverse charging requests,
implementing said reverse charging request by a recognisable tone, light and/or a text message showing up on a screen included in said called party's terminal,
accepting/not accepting the reverse charging request by dialling a certain number or typing a certain password/phrase,
determining, in said intelligent node, based on said dialled number or typed password/phrase if said request has been accepted or not, if accepted, charging said called party (3) for the call, and, if not accepted, charging said calling party (1) for the call or shutting down the call connection.

2. Method as defined in claim 1,
characterized in that said reverse charging request is initiated by said calling party (1).

3. Method as defined in claim 1 or 2,
characterized in that said called party (3) is given the opportunity to initiate said charging request during said call or service.

4. Method as defined in any of the preceding claims,
characterized in that said charging are stored in a storing means within said communication network (2), and that said means of payment is a billing system included in or connected to said communication network (2) sending a bill including said stored charge after said call or service has been carried out.

5. Method as defined in one of the claims 1-3,
characterized in that said means of payment is an account accessible for said communication network (2), where said charging is executed by subtracting the charging amount associated with said call or service directly and instantaneously from said account.

6. Method as defined in claim 5,
characterized in that said request is initiated when said account is empty.

7. Method as defined in any of the preceding claims,
characterized in that said request occurs either in connection with said call or service set-up or during said call or service.
